(19) United States
(12) Patent Application Publication
(10) Pub. No.: US 2016/0241057 A1
(43) Pub. Date: Aug. 18, 2016

(54) MULTIPLE PARALLEL ENERGY STORAGE SYSTEM AND CONTROLLING METHOD OF THE SAME

(71) Applicant: SAMSUNG SDI CO., LTD., Yongin-si (KR)

(72) Inventor: Jongwoon YANG, Yongin-si (KR)

(21) Appl. No.: 14/990,873

(22) Filed: Jan. 8, 2016

(30) Foreign Application Priority Data
Feb. 12, 2015 (KR) 10-2015-0021737

(51) Int. Cl. H02J 7/00; H01M 10/46; H01M 10/44

(52) U.S. Cl. CPC H02J 7/0024; H01M 10/441; H01M 10/46; H02J 7/007; H01M 2220/30

(57) ABSTRACT

There are provided an energy storage system including an energy storage device and a plurality of battery trays connected in parallel, and a method of controlling the same. The method for controlling an energy storage system of a battery tray in an under voltage protection (UVP) status includes performing precharging when a charge voltage is detected, transmitting information indicating that precharging is performed to at least one different tray connected to the battery tray in parallel, and when all of battery trays have performed precharging, simultaneously transmitting information instructing to start charging to the at least one different battery tray.

### CROSS-REFERENCE TO RELATED APPLICATION

Korean Patent Application No. 10-2015-0021737, filed on Feb. 12, 2015, in the Korean Intellectual Property Office, and entitled: “Multiple Parallel Energy Storage System and Controlling Method Of The Same,” is incorporated by reference herein in its entirety.

### BACKGROUND

1. Field

Embodiments relate to an energy storage system including an energy storage device and a plurality of battery trays connected in parallel, and a method of controlling the same.

2. Description of the Related Art

In the midst of destruction of the environment, resource depletion, and the like, interest in a system that may be able to store power and effectively utilize the stored power has increased. Also, interest in new and renewable energy not causing pollution in a power generation process has increased. In general, rechargeable batteries have been actively researched in line with the development of portable electronic devices, e.g., cellular phones, notebook computers, camcorders, personal digital assistants (PDAs), and the like. In particular, various types of rechargeable batteries including a nickel-cadmium battery, a lead storage battery, a nickel metal hybrid battery (NiMH), a lithium-ion battery, a lithium polymer battery, a metal lithium battery, and a zinc-air storage battery have been developed. A rechargeable battery is combined with a circuit to constitute a battery pack, and charging and discharging may be performed through an external terminal of the battery pack.

A peripheral circuit including a charging/discharging circuit may be a printed circuit board (PCB) and subsequently combined with the battery cell. When an external power source is connected through an external terminal of the battery pack, the battery cell is charged by the external power source supplied through the charging/discharging circuit and the external terminal. When a load is connected through the external terminal, power of the battery cell is supplied to the load through the charging/discharging circuit and the external terminal. The charging/discharging circuit controls charging and discharging of the battery cell between the external terminal and the battery cell. In general, a plurality of battery cells may be connected in series and/or parallel according to consumption capacity of a load.

When the energy storage system is in a normal status, both a charge switch and a discharge switch may be in an ON state during a discharging operation. Even in a rest status, both the charge switch and the discharge switch may be in the ON state, remaining unchanged. Also, when the energy storage system is turned to a charging state, both the charge switch and the discharge switch may be in the ON state. Thereafter, when charging is completed, the charge switch may be turned off, while the discharge switch may be maintained in the ON state.

When the energy storage system enters an under voltage protection (UVP) status, both the charge switch and the discharge switch may be turned off. When a charger voltage is supplied, that is, when charging starts, both the charge switch and the discharge switch are turned to the ON state, releasing the UVP status.

### SUMMARY

A method for controlling an energy storage system of a battery tray in an under voltage protection (UVP) status according to an embodiment includes: performing precharging when a charge voltage is detected; transmitting information indicating that precharging is performed to at least one different tray connected to the battery tray in parallel; and when all of battery trays have performed precharging, simultaneously transmitting information instructing to start charging to the at least one different battery tray.

The information indicating that precharging is performed may be transmitted to the at least one different battery tray using a controller area network (CAN) communication.

Transmitting the information instructing to start charging may include simultaneously transmitting information instructing start charging to the at least one different battery tray in a state in which all of the battery trays have performed precharging and in a state in which the information indicating that all of the battery trays performed precharging has been transmitted.

Transmitting the information instructing to start charging may include determining whether the battery tray is a battery tray for transmitting the information instructing to start charging; and when the battery tray is a battery tray for transmitting information instructing to start charging, simultaneously transmitting the information instructing to start charging to the at least one different battery tray.

The method may further include, when the battery tray is not a battery tray for transmitting the information instructing to start charging, receiving information instructing to start charging.

Performing precharging may include: turning off a charge switch and a discharge switch and turning on a precharge switch. Performing precharging may be before, after, or simultaneous with transmitting information.

A battery tray according to another embodiment includes: at least one battery cell; a charge switch and discharge switch connected to the battery cell in series; a precharge switch connected to the charge switch and discharge switch in parallel; and a battery tray control unit connected to the battery cell in series, wherein the tray control unit performs precharging when a charge voltage is detected and transmits information indicating that precharging is performed to at least one different battery tray connected to the battery tray in parallel, and when all of battery trays have performed precharging, the tray control unit performs control to simultaneously transmit information instructing to start charging to the at least one different battery tray.

### BRIEF DESCRIPTION OF THE DRAWINGS

Features will become apparent to those of skill in the art by describing in detail exemplary embodiments with reference to the attached drawings in which:

FIG. 1 illustrates a view of an example of an energy storage system according to an embodiment.

FIG. 2 illustrates a view of an example of a configuration of a battery pack according to an embodiment.

FIG. 3 illustrates a view of an example of a configuration of a battery tray according to an embodiment.

FIG. 4 illustrates a flowchart of a procedure in which an energy storage system returns from an under voltage protection (UVP) status to a normal state according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

It is to be understood that when one element is referred to as being “connected to” or “coupled to” another element, it may be connected directly to or coupled directly to another element or be connected to or coupled to another element, having the other element intervening therebetween. In addition, in the following description, and the word ‘including’ does not preclude the presence of other components and means that an additional component may be included.

Terms such as ‘first’, ‘second’, etc., may be used to describe various components, but the components are not to be construed as being limited to the terms. The terms are used only to distinguish one component from another component. For example, the ‘first’ component may be named the ‘second’ component and the ‘second’ component may also be similarly named the ‘first’ component, without departing from the scope of the disclosure.

Also, elements of the embodiments are independently illustrated to show different characteristic functions, and it does not mean that each element is configured as separate hardware or a single software component. Namely, for the sake of explanation, respective elements are arranged to be included, and at least two of the respective elements may be incorporated into a single element or a single element may be divided into a plurality of elements to perform a function, and the integrated embodiment and divided embodiment of the respective elements are included in the scope of the disclosure unless contrary thereto.

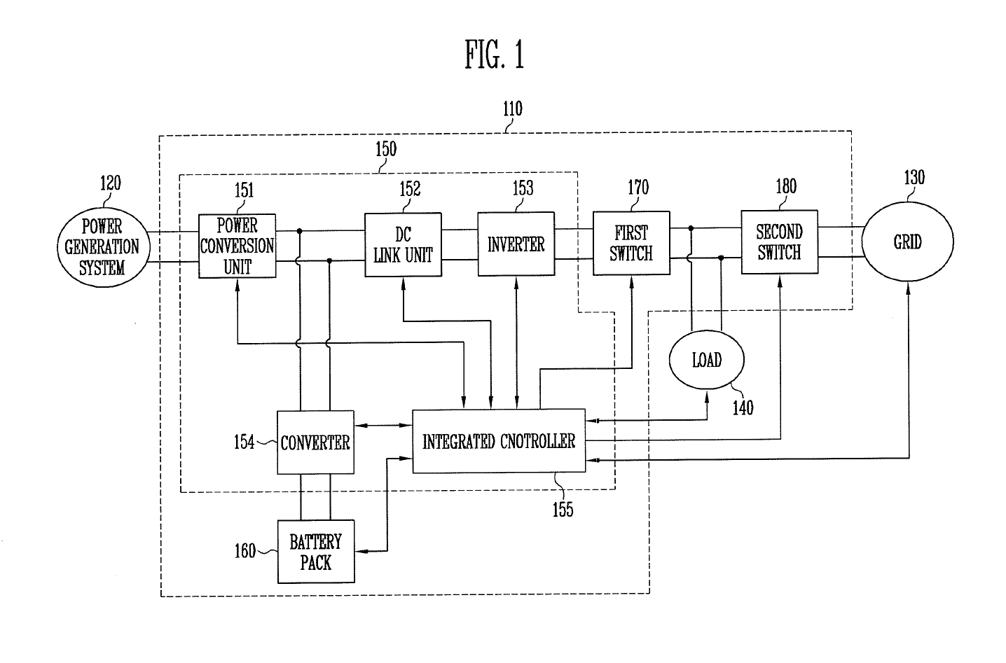

FIG. 1 illustrates a view of an example of an energy storage system according to an embodiment. Referring to FIG. 1, a power storage system 110 according to an embodiment may supply power to a load 140, in tandem with a power generation system 120 and a grid 130.

The power generation system 120 is a system producing electric power using an energy source. The power generation system 120 may supply produced power to a power storage system 110. For example, the power generation system 120 may be a photovoltaic power generation system, a wind power generation system, a tidal power generation system, or any power generation system producing electric power using renewable energy, e.g., solar heat, terrestrial heat, or the like. For example, a solar battery producing electric energy using solar heat, easy to install in homes or factories, may be applied to the power storage system 110. The power generation system 120 may include a plurality of power generation modules in parallel and produces electric power by the power generation modules, thus constituting a large capacity power system.

The grid 130 may include a power plant, a substation, and a power line. When the grid 130 is in a normal status, the grid 130 supplies power to the power storage system 110 such that power may be supplied to the load 140 and/or the battery pack 160, and receives power from the power storage system 110. When the grid 130 is in an abnormal status, power supply from the grid 130 to the power storage system 110 is stopped from operation and power supply from the power storage system 110 to the grid 130 is also stopped.

The load 140 may consume power produced by the power generation system 120, power stored in the battery pack 160, or power supplied form the grid 130. Homes or factories may be an example of the load 140.

The power storage system 110 may store power produced by the power generation system 120 in the battery pack 160 and supply the produced power to the grid 130, may supply power stored in the battery pack 160 to the grid 130, or may store power supplied from the grid 130 in the battery pack 160. When the grid 130 is in an abnormal status, e.g., when power failure occurs, the power storage system 110 may perform an uninterruptible power supply (UPS) operation to supply power to the load 140. Even when the grid 130 is in a normal status, the power storage system 110 may supply power produced by the power generation system 120 or power stored in the battery pack 160 to the load 140.

The power storage system 110 may include a power conversion system 150, the battery pack 160, a first switch 170, and a second switch 180.

The power conversion system 150 converts power of the power generation system 120, the grid 130, and the battery pack 160 into a requested specification and supplies the same to where the power is required. The power conversion system 150 may include a power conversion unit 151, a DC link unit 152, an inverter 153, a converter 154, and an integrated controller 155.

The power conversion unit 151 is a power conversion device connected between the power generation system 120 and the DC link unit 152. The power conversion unit 151 may transfer power produced by the power generation system 120 to the DC link unit 152 and, in this case, the power conversion unit 151 may convert an output voltage into a DC link voltage.

The power conversion unit 151 may be configured as a power conversion circuit, e.g., as a converter or a rectifying circuit, according to types of the power generation system 120. For example, when the power generation system 120 produces DC, the power conversion unit 151 may be a DC/DC converter. Meanwhile, when the power generation system 120 produces AC, the power conversion unit 151 may be a rectifying circuit for converting AC into DC. In particular, when the power generation system 120 is a photovoltaic power generation system, the power conversion unit 151 may include a maximum power point tracking (MPPT) converter performing MPPT controlling to obtain power produced by the power generation system 120 to maximum according to a change in an amount of solar radiation or a temperature. When the power generation system 120 does not produce power, the power conversion unit 151 may be stopped to minimize power consumed by the power conversion circuit.

A DC link voltage may become unstable in magnitude due to a drop in an instantaneous voltage in the grid 130 or generation of a peak load in the load 140. However, the DC link voltage needs to be stabilized for a normal operation of the converter 154 and the inverter 153. Here, the DC link unit 152 may be connected between the power conversion unit 151 and the inverter 153 to uniformly maintain the DC link voltage. For example, a large capacitor may be used as the DC link unit.

The inverter 153 is a power conversion device connected between the DC link unit 152 and the first switch 170. The inverter 153 may include an inverter converting a DC link voltage output from the power generation system 120 and/or the battery pack 160 into an AC voltage of the grid 130, and outputting the same in a discharge mode. Also, in order to store power of the grid 130 in the battery pack 160 in a charge mode, the inverter 153 may include a rectifying circuit rectifying an AC voltage, converting the same into a DC link voltage, and outputting the converted DC link voltage. That is, the inverter 153 may be a bi-directional inverter in which input and output directions may be changed. According to embodiments, the inverter 153 may include a filter for removing harmonics from an AC voltage output to the grid 130. Also, in order to suppress generation of invalid power, the inverter 153 may include a phase locked loop (PLL) for locking a phase of an AC voltage output from the inverter 153 of the grid 130 and a phase of the AC voltage of the grid 130. The inverter 153 may perform additional functions, e.g., limiting a voltage fluctuation range, improving a power factor, removing a DC component, protecting transient phenomenon, and the like. Also, when not in use, operation of the inverter 153 may be stopped to minimize power consumption.

The converter 154 is a power conversion device connected between the DC link unit 152 and the battery pack 160. The converter 154 may include a converter which DC-DC converts power stored in the battery pack 160 into a voltage level required by the inverter 153, i.e., into a DC link voltage, and outputs the same in the discharge mode. Also, the converter 154 may include a converter which DC-DC converts a voltage of power output from the power conversion unit 151 or a voltage of power output from the inverter 153 into a voltage level required by the battery pack 160, i.e., into a charge voltage in the charge mode. That is, the converter 154 may be a bi-directional converter in which input and output directions may be changed. When not required to charge or discharge the battery pack 160, operation of the converter 154 may be stopped to minimize power consumption.

The integrated controller 155 may monitor states of the power generation system 120, the grid 130, the battery pack 160, and the load 140, and may control operations of the power conversion unit 151, the inverter 153, the converter 154, the battery pack 160, the first switch 170, and the second switch 180. For example, the integrated controller 155 may monitor whether a power failure has occurred in the grid 130, whether power is produced by the power generation system 120, and, when the power generation system 120 produces power, may output a charge state of the battery pack 160, power consumption of the load 140, and a time. Also, when power to be supplied to the load 140 is not sufficient because a power failure occurs in the grid 130, or the like, the integrated controller 155 may determine priority levels of power usage devices included in the load 140 and control the load 140 such that power is supplied to the power usage devices, starting from one having the highest priority level.

The first switch 170 and the second switch 180 are connected in series between the inverter 153 and the grid 130, and perform an ON/OFF operation under the control of the integrated controller 155 to control a current flow between the power generation system 120 and the grid 130. ON/OFF of the first switch 170 and the second switch 180 may be determined according to states of the power generation system 120, the grid 130, and the battery pack 160.

In detail, when power of the power generation system 120 and/or the battery pack 160 is supplied to the load 140 or when power of the grid 130 is supplied to the battery pack 160, the first switch 170 is turned on. When power of the power generation system 120 and/or the battery pack 160 is supplied to the grid 130, or when power of the grid 130 is supplied to the load 140 and/or the battery pack 160, the second switch 180 is turned on.

When a power failure occurs in the grid 130, the second switch 180 may be turned off and the first switch 170 may be turned on. That is, power from the power generation system 120 and/or the battery pack is supplied to the load 140, while power supplied to the load 140 from flowing toward the grid 130 is prevented. Accordingly, a unilateral operation of the power storage system 110 is prevented, thus preventing occurrence of an accident in which a worker who works in a power line of the grid 130 from getting shocked by power from the power storage system 110.

As the first switch 170 and the second switch 180, a switching device that can tolerate a large current may be used, e.g., a relay.

The battery pack 160 may receive power from the power generation system 120 and/or the grid 130 and store the same, and supply stored power to the load 140 or the grid 130. The battery pack 160 may include a part storing power and a part controlling the part storing power.

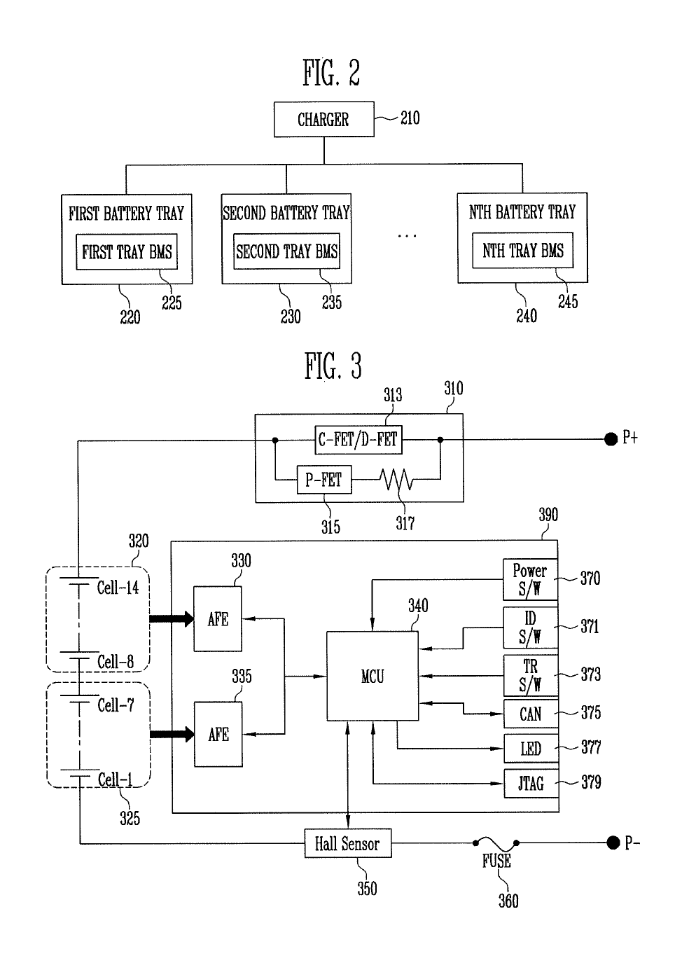

FIG. 2 illustrates a view of an example of a configuration of a battery pack according to an embodiment. Referring to FIG. 2, a battery pack according to an embodiment may include at least two battery trays 220, 230, and 240. Each of the battery trays 220, 230, and 240 may include tray control units 225, 235, and 245, respectively. Here, the tray control units 225, 235, and 246 may be battery management systems (BMS). The plurality of battery trays 220, 230, and 240 connected in parallel may be connected to a charger 210 to be charged. When the plurality of battery trays 220, 230, and 240 are charged, a charge voltage may be applied thereto.

The battery trays 220, 230, and 240 may store power supplied from the outside, i.e., the power generation system 120 and/or the grid 130, and may supply the stored power to the power generation system 120 and/or the grid 130.

Here, the at least two battery trays 220, 230, and 240 may be connected in parallel. Each of the battery trays 220, 230, and 240 may include at least one battery cell. As the battery cell, various rechargeable batteries available to be charged may be used. For example, the rechargeable battery used in the battery cell may be a nickel-cadmium battery, a lead storage battery, a nickel metal hybrid battery (NiMH), a lithium-ion battery, or a lithium polymer battery, but embodiments are not limited thereto.

FIG. 3 illustrates a view of an example of a configuration of a battery tray according to an embodiment. Referring to FIG. 3, the battery tray according to an embodiment may include rechargeable battery cells 320 and 325, and a protective circuit. The protective circuit may include a switch 310 and a tray control unit 390, e.g., a battery management system (BMS). The switch 310 may include a charge switch and a discharge switch 313 and may include a precharge switch 315 connected in parallel thereto. The switch 310 may further include a resistor 317 connected to the precharge switch 315 in series.

The BMS 390 may include at least one analog front end (AFE) 330 and a MBS control unit 340. The MBS control unit 340 may be a microcontroller (MCU). Also, the BMS 390 may further include a power software 370, an identification (ID) software 371, a transmitting (TR) software 373, a controller area network (CAN) communication unit 375, a light emitting diode (LED) 377, and a joint test action group (JTAG) connector 379. Of course, the BMS 390 may not include all of the foregoing components, or may further include a component other than the enumerated components. The CAN communication unit 375, an internal communication protocol of a battery pack, may control communication among the battery trays 220, 230, and 240, and control the battery pack.

Also, the battery tray may further include components such as a Hall sensor 350 and a fuse 360 as illustrated in FIG. 3.

The battery tray may include at least one battery cells 320 and 326 connected in series, and may be realized using various rechargeable batteries. Also, the battery cells 320 and 325 may transmit various types of internal information, for example, cell-related information such as a temperature of a cell, a charge voltage of the cell, and a current amount flowing in the cell to the AFEs 330 and 335.

The AFEs 330 and 335 are connected in parallel between the battery cells 320 and 325 and the switch 310, and may be connected in series between the battery cells 320 and 325 and the MCU 340. The AFEs 330 and 335 may monitor a voltage, a current, a temperature, a remaining power amount, a lifespan, a charge state, and the like. The AFEs 330 and 335 may analog-to-digital convert the measured data and transfer the same to the MCU 340. According to embodiments, the AFEs 330 and 335 may be connected in series or may be a single integrated circuit (IC).

The MCU 340 may control a general operation of the battery tray. For example, the MCU 340 controls operations of the AFEs 330 and 335 and collect monitoring data from the AFEs 330 and 335. The MCU 340 may control other component connected thereto.

The charge switch and discharge switch 313 may be in a high current path in series between the battery cells 320 and 326, and an external terminal to control a flow of a charge current and a discharge current. The charge switch may cut off a charge current and the discharge switch may cut off a discharge current. Each of the charge switch and the discharge switch may be configured as a field effect transistor (FET) and may be controlled by the MCU 340. The charge switch may be referred to as a charge FET (C-FET) and the discharge switch may be referred to as a discharge FET (D-FET).

In existing energy storage systems, in a normal status, both the charge switch and the discharge switch are in an ON state during a discharge operation, on standby, and during a charge operation, and when the charging operation is completed, the charge switch is turned off and the discharge switch is maintained in the ON state. When the energy storage system enters the under voltage protection (UVP) status, both the charge switch and the discharge switch are turned off, and when a charger voltage is input, that is, when charging starts, both the charge switch and the discharge switch are turned on, releasing the UVP status. Here, in the case where the energy storage system includes a plurality of battery trays connected in parallel, when any one first battery tray among the battery trays connected in parallel starts charging, both a charge switch and a discharge switch included in the first battery tray are turned on, and thus, a battery voltage may be a charger voltage. Accordingly, battery trays other than the first battery tray measure the charge voltage to be low, resulting in that the UVP status may not be released. Also, when a charge switch and a discharge switch of any one battery tray are turned on to start charging, multiple parallel reference charge current flows in to cause an overcurrent protecting operation or an inrush, leading to a possibility of generation of switch failure.

In contrast, in the case of the energy storage system according to an embodiment, since the battery tray further includes the precharge switch 315 as illustrated, such a problem may be resolved. The precharge switch 315 may be configured as an FET, and it may be referred to as a P-FET 315.

That is, in the case of the energy storage system according to an embodiment, when the energy storage system enters the UVP status, if a charger voltage is applied, the precharge switch 315, instead of the charge switch C-FET and the discharge switch D-FET 313, may be first turned on to perform precharging. The battery tray, to which a charge voltage is applied to perform precharging, may transmit information indicating that the charge voltage has been applied to perform precharging, to other battery trays connected thereto in parallel. Here, the information indicating that precharging is performed or the information indicating that the charge voltage has been applied may be the same as a charger detection flag, for example. The information indicating that precharging is performed may be transmitted to other battery trays through CAN communication.

Thereafter, when all the battery trays in the UVP status have performed precharging, any one among the battery trays may simultaneously transmit information instructing to start charging to at least one different battery tray connected in parallel. According to embodiments, when all the batteries have performed precharging and the charger detection flag is set, the information instructing to start charging may be simultaneously transmit other battery trays. That is, when all the battery trays have transmitted the charger detection flag, the information instructing to start charging may be transmitted to other battery trays.

A battery tray which has received the information instructing to start charging and the battery tray which has transmitted the information instructing to start charging may turn on the charge switch C-FET and discharge switch D-FET 313 and turn off the precharge switch P-FET 315, thus exiting the UVP status. Accordingly, the energy storage system may enter a normal status to perform a charging/discharging operation. The information instructing to start charging may be a charger start sync. signal, for example. Alternatively, the information instructing to start charging may be a normal operation signal, i.e., a signal indicating to start a normal charging operation. Also, the information instructing to start charging may be transmitted to other battery tray through CAN communication. According to embodiments, the battery tray transmitting the information instructing to start charging may be set with respect to the lowest one or the highest one of CAN ID numbers of the plurality of trays.

According to an embodiment, even when the energy storage system enters the UVP status, the precharge switch 315, instead of the charge/discharge switch 313, is turned on, whereby other battery trays are prevented from measuring a charger voltage to be low. That is, due to the resistor 317 connected in series to the precharge switch 315, a battery voltage is prevented from being equal to the charger voltage, whereby other battery trays in the UVP status are prevented from measuring a charger voltage to be low. Also, since the information instructing to start charging is simultaneously transmitted (or received) in a state in which the battery trays in the UVP status have performed precharging, all the battery trays may exit the UVP status.

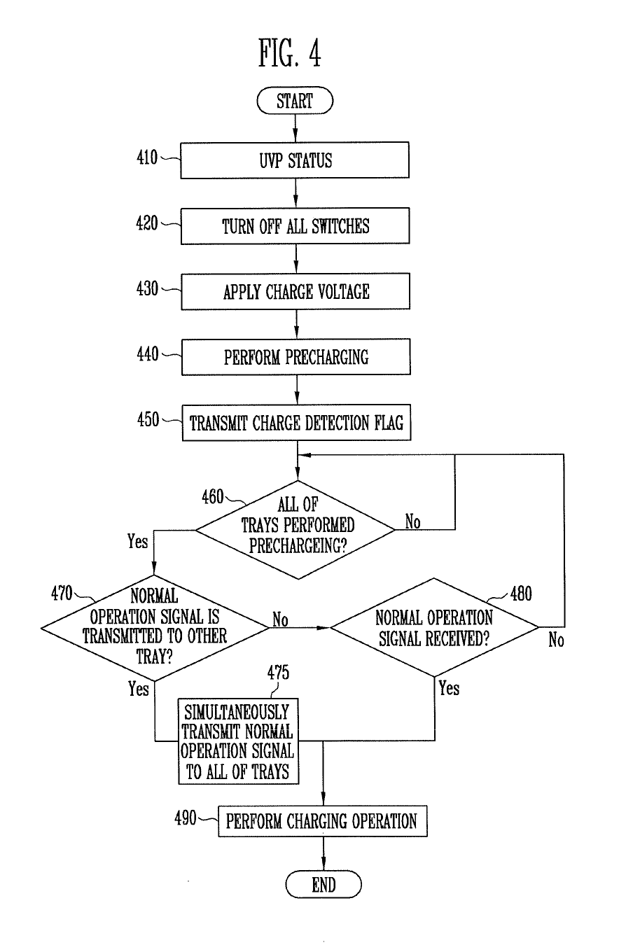

FIG. 4 illustrates a view of an example of a procedure in which an energy storage system returns from an under voltage protection (UVP) status to a normal status according to an embodiment.

Referring to FIG. 4, a battery tray may enter a UVP status in operation 410. Accordingly, all the switches C-FET, D-FET, and P-FET of the battery tray may be turned off in operation 420.

Thereafter, the battery tray determines whether a charge voltage is applied in operation 430, and when a charge voltage is applied, the battery tray may perform precharging in operation 440. Here, in the battery tray, the precharge switch P-FET 315 may be changed to be turned on, but the charge switch C-FET and the discharge switch D-FET 313 may be maintained in the OFF state.

Thereafter, the battery tray may transmit information indicating that precharging is performed to other battery trays connected thereto in parallel. Here, the battery tray which has performed precharging may transmit the foregoing information to other battery trays through CAN communication. Meanwhile, according to an embodiment, performing precharging in operation 440 and transmitting the information indicating that precharging is performed in operation 450 may be made in reverse order, and alternatively, performing precharging and transmitting the information indicating that precharging is performed may be made simultaneously. Also, as described above, the information indicating that precharging is performed or the information indicating that the charge voltage has been applied may be the same as a charger detection flag, for example.

Thereafter, it may be determined whether precharging of all the battery trays has been performed in operation 460. Here, according to an embodiment, it may be determined whether the charger detection flag has been set, i.e., whether all the battery trays have transmitted the charger detection flag.

When precharging of all the battery trays has not been performed, the battery trays are on standby. When precharging of all the battery trays has been performed, it may be determined whether to transmit information indicating that charging starts to other battery trays in operation 470. That is, the battery trays may determine whether they are a reference battery tray for transmitting information instructing to start charging to other battery trays connected thereto in parallel according to preset conditions. This may be determined according to a CAN ID number, for example, as described above.

When a battery tray is a battery tray for transmitting information instructing to start charging, the battery tray may simultaneously transmit a normal operation signal to other battery trays connected thereto in operation 475. The normal operation signal may be transmitted through CAN communication. Also, a charging operation may be performed in operation 490. That is, the battery tray may exit the UVP status by turning on the charge switch C-FET and discharge switch D-FET 313, and turning off the precharge switch P-FET 315. Accordingly, the energy storage system may enter the normal status allowing a charge/discharge operation to be performed.

When a battery tray is not a battery tray for transmitting information instructing to start charging, it may be determined whether information instructing to start charging has been received in operation 480. When the information instructing to start charging is received, the battery tray may turn on the C-FET and the D-FET 313 and turn off the P-FET 315 to perform charge/discharge operation in operation S490. However, when the information instructing to start charging is not received, the battery tray may return to operation 460 to perform a process of determining whether all of the other battery trays in the UVP status have performed precharging.

As described above, when the battery module 200 including the battery cells 100 according to an embodiment, adjacent battery cells may be easily serially connected or may be easily connected in parallel. Therefore, it is possible to reduce the number of parts and working processes and thus, to reduce manufacturing cost.

By way of summation and review, an embodiment may prevent failure of a switch, for example, a field effect transistor (FET), when an energy storage system including a plurality of battery trays connected in parallel returns to charging from an under voltage protection (UVP) status. Another embodiment may reduce or prevent generation of tray imbalance by simultaneously starting charging of a plurality of battery trays connected in parallel.

The methods and processes described herein may be performed by code or instructions to be executed by a computer, processor, manager, or controller. Because the algorithms that form the basis of the methods (or operations of the computer, processor, or controller) are described in detail, the code or instructions for implementing the operations of the method embodiments may transform the computer, processor, or controller into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, or controller which is to execute the code or instructions for performing the method embodiments described herein.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for controlling an energy storage system of a battery tray in an under voltage protection (UVP) status, the method comprising:
performing precharging when a charge voltage is detected;
transmitting information indicating that precharging is performed to at least one different tray connected to the battery tray in parallel; and
when all of battery trays have performed precharging, simultaneously transmitting information instructing to start charging to the at least one different battery tray.

2. The method as claimed in claim 1, wherein the information indicating that precharging is performed is transmitted to the at least one different battery tray using a controller area network (CAN) communication.

3. The method as claimed in claim 1, wherein transmitting the information instructing to start charging includes simultaneously transmitting information instructing start charging to the at least one different battery tray in a state in which all of the battery trays have performed precharging and in a state in which the information indicating that all of the battery trays performed precharging has been transmitted.

4. The method as claimed in claim 1, wherein transmitting the information instructing to start charging includes:
determining whether the battery tray is a battery tray for transmitting the information instructing to start charging; and
when the battery tray is a battery tray for transmitting information instructing to start charging, simultaneously transmitting the information instructing to start charging to the at least one different battery tray.

5. The method as claimed in claim 4, further comprising:
when the battery tray is not a battery tray for transmitting the information instructing to start charging, receiving information instructing to start charging.

6. The method as claimed in claim 1, wherein performing precharging includes turning off a charge switch and a discharge switch and turning on a precharge switch.

7. The method as claimed in claim 1, wherein performing precharging is after transmitting information.

8. The method as claimed in claim 1, wherein performing precharging and transmitting information is simultaneous.

9. A battery tray, comprising:
at least one battery cell;
a charge switch and a discharge switch connected to the battery cell in series;
a precharge switch connected to the charge switch and the discharge switch in parallel; and
a battery tray control unit connected to the at least one battery cell in series,
wherein the tray control unit performs precharging when a charge voltage is detected and transmits information indicating that precharging is performed to at least one different battery tray connected to the battery tray in parallel, and when all of battery trays have performed precharging, the tray control unit to simultaneously transmit information instructing to start charging to the at least one different battery tray.

10. The battery tray as claimed in claim 9, further comprising:
a controller area network (CAN) communication unit to transmit the information indicating that precharging is performed to the at least one different battery tray.

11. The battery tray as claimed in claim 9, wherein the tray control unit is to determine whether the battery tray is a battery tray for transmitting the information instructing to start charging, and, when the battery tray is a battery tray for transmitting information instructing to start charging, the tray control unit is to simultaneously transmit the information instructing to start charging to the at least one different battery tray.

12. The battery tray as claimed in claim 9, wherein when performing precharging, the tray control unit turns off the charge switch and the discharge switch and turns on the precharge switch.
